(19) United States
(12) Patent Application Publication
(10) Pub. No.: US 2023/0225299 A1
(43) Pub. Date: Jul. 20, 2023

(54) IMPROVED ATTACHMENT SYSTEMS AND METHODS FOR AQUATIC BASKETS

(71) Applicant: SEAPA IP PTY LTD, Brisbane (AU)

(72) Inventor: Garry THOMPSON, Brisbane (AU)

(21) Appl. No.: 18/007,534

(22) PCT Filed: Jun. 9, 2021
(86) PCT No.: PCT/AU2021/050577

§ 371 Date: Dec. 1, 2022

(30) Foreign Application Priority Data
Jun. 10, 2020 (AU) 2020901905
Aug. 27, 2020 (AU) 2020903068

(51) Int. Cl. A01K 61/65; A01K 61/50

(52) U.S. Cl. CPC A01K 61/65; A01K 61/50

(57) ABSTRACT

A system (100) and method for attaching an aquatic basket (102) to a longline in an aquaculture farming environment. The system includes the basket (102), a longline engagement means (104, 105), and a locking bar (106) configured for slidable engagement with one or both of the engagement means and basket (102).

### FIELD OF THE INVENTION

The present description relates to improvements in systems, methods and devices for use in the aquaculture farming environment.

### BACKGROUND OF THE INVENTION

Conventional devices exist for attaching a basket to a longline. Such devices are cumbersome to interact with, and involve a significant amount of manual resources during harvesting or maintenance operations. Occasionally, when one basket become defective for whatever reason, the needed replacement of the damaged basket becomes problematic since an entire section of baskets might need to be replaced just to replace the damaged basket. Not only is there significant manual labour involved, but added expense in replacement of basket(s), or parts of baskets, that might need replacement themselves. Accordingly, there exists a need to provide an improved system, device, and method less prone to the shortcomings of conventional systems and devices.

It will be clearly understood that, if a prior art publication is referred to herein, this reference does not constitute an admission that the publication forms part of the common general knowledge in the art in Australia or in any other country.

### SUMMARY

The present disclosure generally relates to a system, device and method for attaching an aquatic basket to a longline or other structure in an aquatic farming environment. It will be understood that when the term “longline” is used herein, other structures such as a trestle or ladder are envisioned for use with embodiments described below. In one or more preferred embodiments, there is described a locking bar which interacts with the basket and an engagement mechanism that attaches to the longline. The locking bar and engagement mechanism may be configured for use with a variety of situations, such as, but not limited to, use with one or more basket floats and/or basket clips. The locking bar and engagement mechanism may be configured for a variety of orientations so that the length of the basket is generally parallel to the longline, or at another angle, for example, perpendicular to the longline as desired for the needed situation.

The present disclosure in one preferred aspect provides for a system for attaching an aquatic basket to a longline in an aquaculture farming environment. The system comprises an aquaculture basket configured to hold aquatic life therein, the basket having a first end, a second end opposite the first end, an upper surface, a lower surface, and a length from the first end to the second end, the upper surface including at least one aperture oriented along the length. The system further comprises a longline engagement means configured to hold the basket to the longline. The system also further comprises a locking bar configured for slidable engagement with at least one aperture of the upper surface of the basket and a portion of the longline engagement means to releasably secure the basket to the longline engagement means.

In another preferred aspect, the present disclosure provides for a quick release for engaging an aquaculture basket to a float and a longline. The quick release comprises an upper body portion including a through-aperture configured to receive at least a portion of the longline therethrough. The upper body portion comprises an engagement means configured to secure to the float a lower body portion configured to slidably receive a portion of a locking bar to secure the basket to the lower body portion.

In a further preferred aspect, the present disclosure provides for a quick release for engaging an aquaculture basket to a longline. The quick release comprises a locking bar, and a basket clip including a first end configured to clip onto the longline, and a second end opposite the first end, the second end including a bottom bar. The quick release also comprises a clip lock including a curvilinear upper surface, an inwardly oriented curvilinear recess configured to receive the bottom bar of the basket clip therein, and a lower surface including an engagement means configured to slidably receive the locking bar.

In yet another preferred aspect, the present disclosure provides a method for attaching an aquatic basket to a longline in an aquaculture farming environment. The method comprises attaching an engagement means to the longline; positioning the basket proximate the engagement means; and sliding a locking bar through the engagement means to secure the basket to the engagement means.

In another preferred aspect, the present disclosure provides for an apparatus for aquaculture farming. The apparatus comprises a piece of durable material which is deformable so as to substantially create an enclosure such as a basket for housing a farmed aquaculture species. The piece of durable material comprises engagement means so that a first part of the durable material can engage with a second part thereof and thereby retain the durable material in the desired deformed state, substantially as an enclosure. The shape of the durable material is such that once in the enclosure form, there are no gaps between engaged parts which are sufficiently large enough to allow an individual of the farmed aquaculture species from exiting the enclosure.

In a further preferred aspect, the present disclosure provides for an assembly for attaching an aquaculture basket to a longline. The assembly comprises a plurality of pre-formed thermoplastic components which are together operable to facilitate rotation of the basket in at least two planes.

In yet another preferred aspect, the present disclosure provides an elongate member for attachment to and along the axis of an aquaculture basket to provide rigidity and support to the basket.

It is to be understood that both the foregoing general description and the following detailed description are exemplary and explanatory only and are not restrictive of the invention, as claimed. In the present specification and claims, the word “comprising” and its derivatives including “comprises” and “comprise” include each of the stated integers, but does not exclude the inclusion of one or more further integers. It will be appreciated that reference herein to “preferred” or “preferably” is intended as exemplary only. The claims as filed and attached with this specification are hereby incorporated by reference into the text of the present description.

The accompanying drawings, which are incorporated in and constitute a part of this specification, illustrate several embodiments of the invention and together with the description, serve to explain the principles of the invention.

### BRIEF DESCRIPTION OF THE FIGURES

FIG. 1 is a perspective view of a system including an aquaculture basket, locking bar and clip assembly configured to engage the basket to a longline in accordance with a preferred embodiment of the present description.

FIG. 2 is an upper perspective view of an aquaculture basket mesh sheet prior to rolling into its basket form.

FIG. 3 is a perspective view of an endcap of the basket of FIG. 1.

FIG. 4 is a perspective view of the locking bar of FIG. 1.

FIG. 5 is a perspective view of a clip lock of the clip assembly of the system of FIG. 1.

FIG. 6 is a perspective view of a basket clip of the clip assembly of FIG. 1.

FIG. 7 is a perspective view of the basket and locking bar of the system of FIG. 1.

FIG. 7A is a partial expanded view of locking bar engagement loop of FIG. 7 with a latch catch.

FIG. 8 is a perspective view of the basket of FIG. 7 with the locking bar being partially engaged with the basket.

FIG. 9 is a perspective view of the basket and locking bar of FIG. 7 with the locking bar fixed in a latched position within a latch catch loop.

FIG. 9A is a partial expanded view of the latch catch loop of FIG. 9.

FIG. 10 is a perspective view of the basket and locking bar of FIG. 9 with the locking bar advanced through the loops and a distal end of the locking bar having been depressed to permit the further advancement of the locking bar through the latch catch loop.

FIG. 11 is a perspective view of the basket and locking bar of FIG. 10 with the locking bar pushed back through the loops and the distal end of the locking bar re-engaging with the latch catch loop to secure the locking bar in position along the top of the basket.

FIG. 12 is a perspective view of a float casing for use with another preferred embodiment of the present disclosure.

FIG. 13 is a perspective view of a flip adaptor for securing the float casing of FIG. 12 to an aquaculture basket.

FIG. 14 is an exploded perspective view of the float casing of FIG. 12 and the flip adaptor of FIG. 13 engaged to the aquaculture basket.

FIG. 15 is a left perspective view of the float casing, and basket of FIG. 14 engaged with one another about a longline, with a locking bar inserted between the float and basket.

FIG. 16 is a partial perspective view of the float and basket of FIG. 15, showing the float locking mechanism in accordance with a preferred embodiment of the present description.

FIG. 17 is a perspective view of a system including an aquaculture basket and locking bar in accordance with another preferred embodiment of the present disclosure.

FIG. 18 is an upper perspective view of an aquaculture basket mesh sheet prior to rolling into its basket form shown in FIG. 17.

FIG. 19 is a partial side elevation view of a centre portion of the mesh sheet of FIG. 18.

FIG. 20 is close-up perspective view of clip lock positioned for engagement with the basket of FIG. 17.

FIG. 21 is a close-up perspective view showing an ID plate engageable with the basket of FIG. 17.

### DETAILED DESCRIPTION OF PREFERRED EMBODIMENTS

It is to be understood that both the foregoing general description and the following detailed description are exemplary and explanatory only and are not restrictive of the invention, as claimed. In the present specification and claims, the word “comprising” and its derivatives including “comprises” and “comprise” include each of the stated integers, but does not exclude the inclusion of one or more further integers. It will be appreciated that reference herein to “preferred” or “preferably” is intended as exemplary only. The claims as filed and attached with this specification are hereby incorporated by reference into the text of the present description.

The present disclosure in one preferred aspect provides for a system for attaching an aquatic basket to a longline in an aquaculture farming environment. The system comprises an aquaculture basket configured to hold aquatic life therein. The basket is suitable for a wide range of farmed aquatic life, for example sea urchins, scallops, oysters and other shellfish. In this aspect the basket has a first end, a second end opposite the first end, an upper surface, a lower surface, and a length from the first end to the second end, the upper surface including at least one aperture oriented along the length. The system further comprises a longline engagement means configured to hold the basket to the longline. The system also further comprises a locking bar configured for engagement with at least one aperture of the upper surface of the basket and a portion of the longline engagement means to releasably secure the basket to the longline engagement means. The locking bar may engage with the basket and the longline engagement means in any suitable way. In some embodiments, it slidably engages with both so as to releasably lock the basket to the longline engagement means. In some embodiments, it may comprise a latch mechanism which may for example comprise one or more deformable components which deform so as to enable latch together.

In some embodiments the longline engagement means comprises: an upper body portion including a through-aperture configured to receive at least a portion of the longline therethrough; and a lower body portion configured to receive a portion of said locking bar (for example, slidably receive) to secure the basket to said lower body portion. The longline engagement means may also be configured to be engageable to a basket float.

In some embodiments, the longline engagement means is configured to permit disengagement of the basket while remaining engaged to the float. It will be appreciated that in some embodiments, it is configured to permit disengagement of the float while remaining engaged to the basket. In some embodiments, the longline engagement means is configured to be located between the float and the basket when the basket and float are engaged to it.

Some preferred embodiments comprise a plurality of longline engagement means configured for engagement with the locking bar to releasably secure the basket to the longline at a plurality of locations.

In some preferred embodiments, the longline engagement means comprises a basket clip and separate clip lock engageable with one another. The clip lock may be configured to slidably receive a portion of said locking bar along a bottom surface of said clip lock to entrap said clip between said locking bar and said clip lock. The clip lock may also comprise a recess configured to receive a lower portion of the basket clip therein.

In another preferred aspect, the present disclosure provides for a quick release for engaging an aquaculture basket to a float and a longline. The quick release comprises an upper body portion including a through-aperture configured to receive at least a portion of the longline therethrough. The upper body portion comprises an engagement means configured to secure to the float a lower body portion configured to slidably receive a portion of a locking bar to secure the basket to the lower body portion.

In some embodiments, the lower body portion is oriented transverse to said upper body portion so that the basket is secured to the longline with its length perpendicular to the longline. In some embodiments, the lower body portion is oriented parallel to said upper body portion so that the basket is secured to the longline with its length parallel with the longline. The upper and lower body portions in some embodiments each have an overall length that is substantially equal. The through aperture of the upper body portion may in some embodiments have a complete perimeter so that the longline is strung through the quick release to engage the quick release to the longline. In other embodiments, the upper body portion may engage the longline in another suitable manner, provided that it is secure so that the basket does not become inadvertently detached from the longline.

In a further preferred aspect, the present disclosure provides for a quick release for engaging an aquaculture basket to a longline. The quick release comprises a locking bar, and a basket clip including a first end configured to clip onto the longline, and a second end opposite the first end, the second end including a bottom bar. The quick release also comprises a clip lock including a curvilinear upper surface, an inwardly oriented curvilinear recess configured to receive the bottom bar of the basket clip therein, and a lower surface including an engagement means configured to slidably receive the locking bar. The dimensions of the components of the quick bar should be sufficient so as to be robust and reduce the effect of wear and tear up on them by floating material (such as sand) in the surrounding water. A further advantage of a robust quick release according to this aspect is that it is less subject to wear than traditional attachment means and is readily replaceable once wear eventually becomes an issue.

In some embodiments the locking bar has a length approximately equal to a length of the basket. The first end of the basket clip may be hook-shaped, This enables ready engagement with and conformity with the shape of the long line whilst enabling free movement for the basket to swing back and forth on the longline to increase rumbling. In some embodiments the first and second ends of the basket clip each comprise a through hole having a central axis that are parallel to one another. In some embodiments, the lower surface of the clip lock comprises a plurality of feet configured to engage with a locking bar. The lower surface of the clip lock may be configured to slidably receive said locking bar in a transverse orientation relative to the longline. The lower surface of the clip lock may also be configured to slidably receive the locking bar in a parallel orientation relative to the longline. Other methods of attaching the clip lock to the basket are also within the scope of this disclosure.

In yet another preferred aspect, the present disclosure provides a method for attaching an aquatic basket to a longline in an aquaculture farming environment. The method comprises attaching an engagement means to the longline; positioning the basket proximate the engagement means; and sliding a locking bar through the engagement means to secure the basket to the engagement means.

In some embodiments, the step of sliding the locking bar through the engagement means comprises sliding the locking bar through a plurality of engagement means. The step of sliding the locking bar through the engagement means may also comprise sliding the locking bar through an engagement means that is secured to a float. In some embodiments, the method comprises disengaging the basket from the float while keeping the float engaged to the longline. In some embodiments, the method comprises flipping the basket about the longline. The method may comprise flipping the basket about the longline so that a length of the basket is flipped around the longline. It also may comprise flipping the basket about the longline while the float is engaged with the longline and cage.

In another preferred aspect, the present disclosure provides for an apparatus for aquaculture farming. The apparatus comprises a piece of durable material which is foldable or deformable so as to substantially create an enclosure such as a basket for housing the farmed aquaculture species. The piece of durable material comprises engagement means so that a first part of the durable material can engage with a second part thereof and thereby retain the durable material in the desired deformed state, substantially as an enclosure. The shape of the durable material is such that once in the enclosure form, there are no gaps between engaged parts which are sufficiently large enough to allow an individual of the farmed aquaculture species from exiting the enclosure. Such gaps are present in prior art devices and form ‘siphons’ through which farmed aquaculture species can escape or exit the basket along with water flow through the gaps.

The piece of durable material may be of any suitable shape, but is preferably a sheet which is substantially rectangular in shape so as to enable it to be rolled into a substantially cylindrical form of enclosure. By providing the material as a flat sheet costs can be reduced in terms of production, transport and storage (for example by flat packing the product). The durable material may be of any suitable type and is preferably durable in a marine environment and so may for example comprise a plastic such as polypropylene. The engagement means of the piece of durable material may comprise any suitable components. In some simple yet preferred components it comprises male and female parts for interlocking, such as a tab and slot arrangement.

The apparatus according to this aspect preferably comprises one or more caps to close any gaps left after deforming the durable material into the enclosure form. In a preferred embodiment, the enclosure is substantially cylindrical and preferably with a substantially ovoid cross section. In such an embodiment, the apparatus comprises two caps, one for each end of the enclosure. It will be appreciated that the attachment of the caps as described herein preferably also affords no gaps which are sufficiently large enough to allow an individual of the farmed aquaculture species from exiting the enclosure. Other configurations are also contemplated in the present disclosure, for example a piece of durable material that is deformable or foldable so as to form the entire enclosure or basket, so that no caps are required. Again, this may be in any suitable enclosure or basket shape, but a preferable shape would be a cylinder with an ovoid cross section. The piece of durable material before folding or deformation would comprise a rectangle shape with a substantially ovoid section at each of the shorter ends which will, once folded each comprise the end caps.

In a further preferred aspect, the present disclosure provides for an assembly for attaching an aquaculture basket to a longline. The assembly comprises a plurality of pre-formed components which are together operable to facilitate rotation of the basket in at least two planes. By enabling rotational movement across multiple planes the assembly of this aspect of the disclosure enables enhanced movement of the aquaculture basket and therefore better rumbling. The assembly is preferably made from a durable material that is suitable for use in an environment of prolonged exposure to a marine environment. The at least two planes of rotation may be of any suitable orientation. In some preferred embodiments they are perpendicular to each other, though they do not have to be.

In yet another preferred aspect, the present disclosure provides an elongate member for attachment to and along the axis of an aquaculture basket to provide rigidity and support to the basket. The elongate member may be attached to the aquaculture basket in any suitable way. In some embodiments, it may simply clip on to the basket. In other embodiments, it may comprise a locking bar described herein and for example may be threaded through locking apertures or other engagement means of the basket. It may for example additionally be used to releasably engage other components to the basket such as a quick release, a clip lock, a float, an assembly, or any other apparatus which may usefully be attached to the basket. The elongate member preferably is sufficiently wide so as to provide shade for the aquaculture species being farmed within the basket and is preferably sufficiently structurally rigid so as to provide additional rigidity to the basket. Some embodiments comprise an elongate member which attaches to the basket without use of a locking bar (for example with clips or some other means) and is engageable with a separate locking bar as herein described and preferably engages with the locking bar in the same way. An elongate member according to this aspect (whether or not it comprises or is a locking bar) may in some preferred embodiments comprise a plurality and preferably more than two locations for attachment of other components.

Reference will now be made in detail to the present preferred embodiments of the invention, examples of which are illustrated in the accompanying drawings.

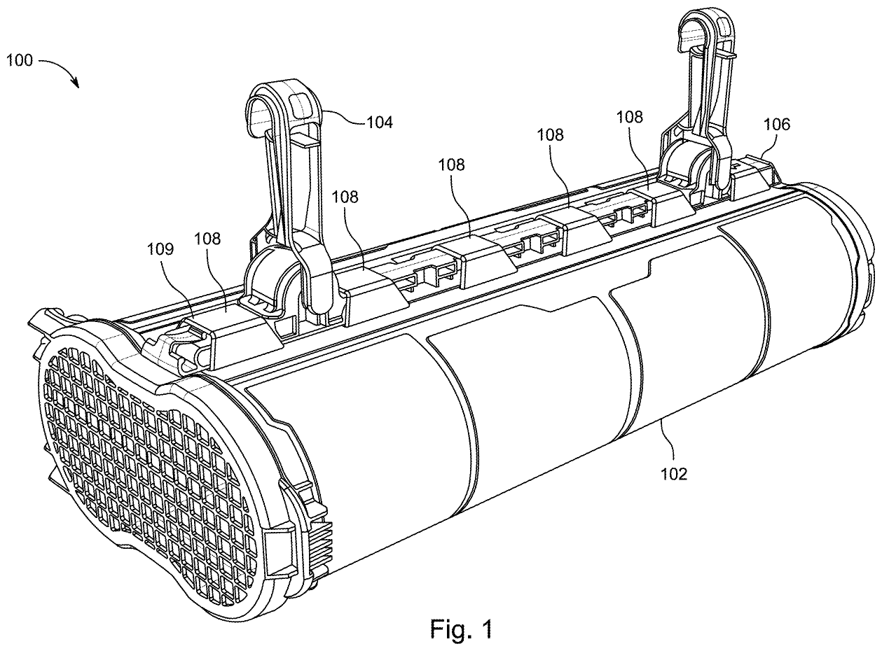

FIGS. 1 to 5 show a preferred embodiment of a system 100 for attaching an aquatic basket 102 to a longline in an aquaculture farming environment. System 100 includes a longline engagement means, in the embodiment illustrated in FIGS. 1-5, in the form of a clip assembly 104, which is engaged with the basket 102 via a locking bar 106 that is slidably received in a plurality of loops 108. Sliding locking bar 106 through loops 108 not only secures the basket in a rolled, substantially ovoid cross sectioned form (to be described further below), but also engages the clip to the basket to attach the basket to the longline. BY sliding locking bar 106 out of loops 108 a user can disengage basket 102 from clip assembly 104, and therefore, detach it from the longline in an efficient and expeditious manner. The preferred elements of the system and their interrelationship are described below.

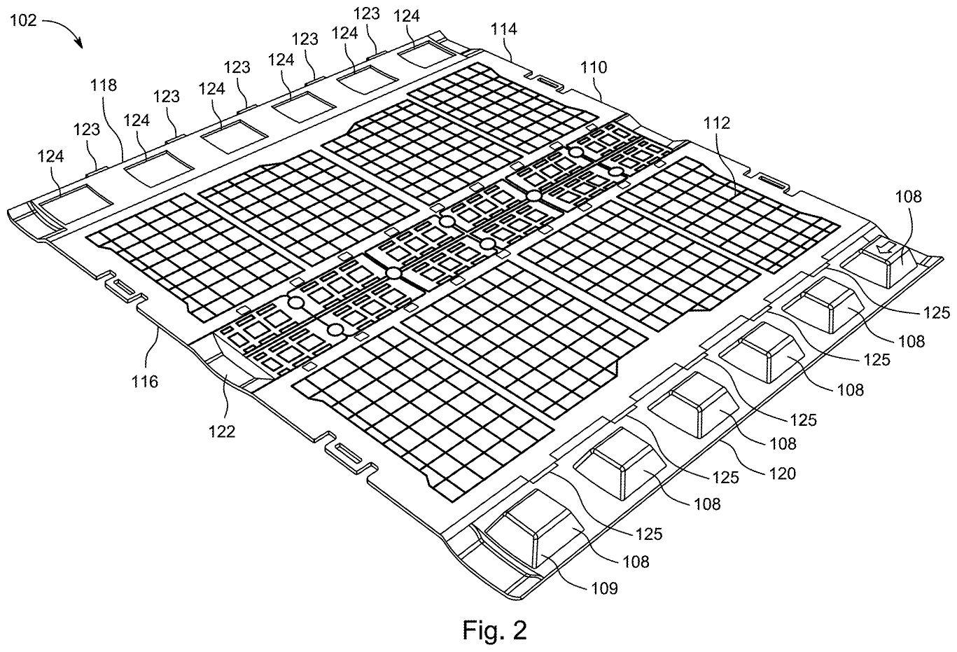

Referring to now to FIG. 2, basket 102 is preferably formed from a sheet 110 of mesh material 112 which can be of any suitable marine-durable material, but is preferably a plastic such as polypropylene. Sheet 110 includes a first end 114, a second end 116, a first side 118, a second side 120, and a centre portion 122. At least one, more preferably, a plurality of loop apertures 124 are arrayed along first side 118. Each loop aperture 124 is sized and configured to engage with a corresponding loop 108 when sheet 110 is deformed or rolled into the basket configuration. Second side 120 of sheet 110 includes at least one, more preferably, a plurality of loops 108 arrayed there along. Centre portion 122 is preferably configured so that when sheet 110 is rolled into the basket configuration, centre portion 122 is indented along its length, or in a generally concave shape from a side cross sectional perspective. The concave configuration adds strength to the basket and promotes rumbling off contained farmed aquaculture species, such as oysters. It will be appreciated that basket 102 may be formed in a variety of ways so that the bottom of the basket is flat or even convex if desired, and depending upon the intended use. In some preferred embodiments, the basked base is concave which provides for additional strength and assists to increase oyster movement and therefore better production. Preferably the basked has a substantially ovoid cross section which promotes rumble or movement. The basket can be of any suitable volume. For example only, it can be greater or less than 15 It, and preferably approximately 20 It-40 It which enables more stock to be produced per basket than traditional basket based systems. Some preferred embodiments comprise one or marked fill lines on the basket to assist users with knowing the extent to which to fill the basket during operation.

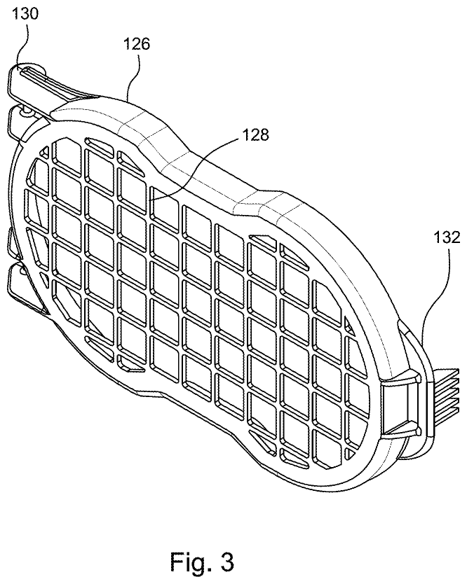

Once sheet 110 is rolled into the basket configuration, male locator tabs 123 fit into corresponding female tab apertures 125 to secure the sheet into the basket configuration, as shown in FIG. 1. FIG. 3 shows an endcap 126 preferably made of a mesh material 128. Endcap 126 includes a hinge 130 and a latch 132 opposite thereof along the width of the end cap. Endcap 126 preferably functions as a swing door when engaged to the basket body which makes it easier to use. It will be appreciated that other forms of closures may be utilised, and that the endcap as shown is only exemplary. As described elsewhere herein, in some embodiments, an endcap may be integrally formed with and is part of sheet 110.

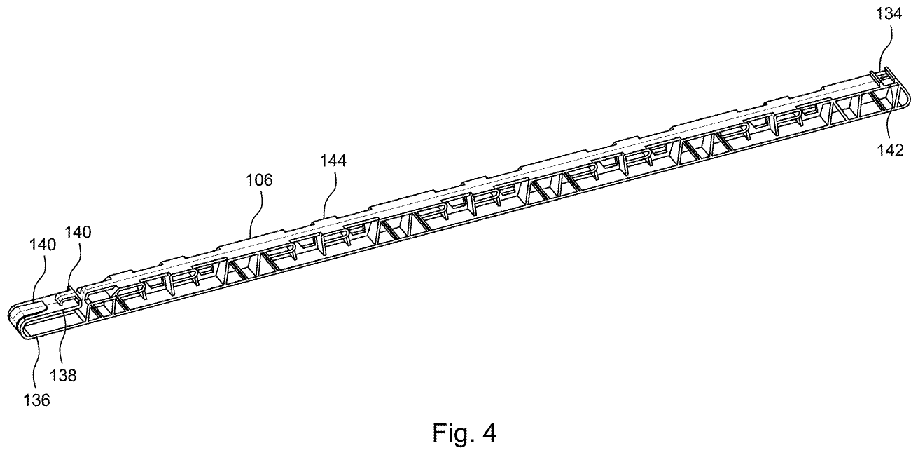

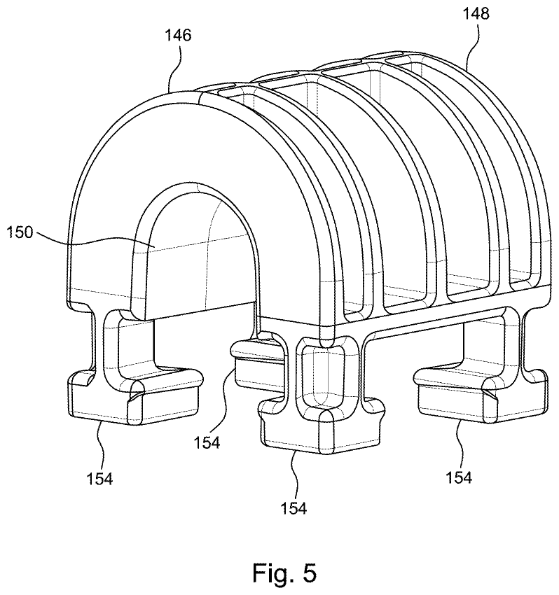

FIG. 4 shows locking bar 106. Locking bar 106 has a proximal end 134, a distal end 136, and a length from the proximal end to the distal end. Distal end 136 includes a latch 138 having two tabs 140 that are configured to engage the locking bar in place once locking bar 106 is slid through loops 108. The engagement of locking bar 106 with loops 108 will be described in further detail below. Proximal end 134 includes an end stop 142 to limit the insertion depth of the locking bar into the array of loops. Locking bar 106 includes a plurality of attachment points 144 configured to engage with a clip lock 146 (FIG. 5) to secure the basket to the clip lock. The engagement of locking bar 106 with clip lock 146 will also be further described below.

FIG. 5 shows clip lock 146 preferably generally in the cross-sectional form of an arch or truncated or flattened oval. Clip lock 146 includes a curvilinear upper surface 148, an inner recess 150 generally having a curvilinear shape to match upper exterior surface 148, and a lower surface. The lower surface includes a plurality of tabs or engagement feet 154 sized and configured or shaped to engage with locking bar 106.

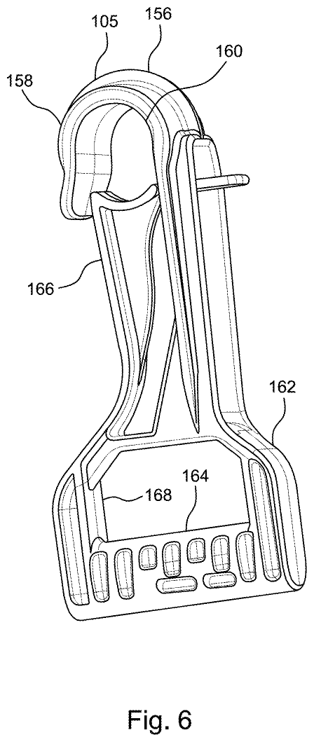

Referring now to FIG. 6, a basket clip 105 is shown. Clip 105 includes a first end 156 generally in the shape of a hook 158 forming a first through hole 160, and a second end 162 having a bottom bar 164. Hook 158 includes a biased tab 166 to allow clip 105 to clip onto a longline. Bottom bar 164 preferably forms a second through hole 168 with the rest of the body of clip 105. Through holes 160 and 168 each have a central longitudinal axis that are parallel to one another. It will be appreciated that the through holes could be oriented to be perpendicular to one another if desired. Bottom bar 164 is preferably thickened, sized and shaped to accommodate engagement with clip lock 146. Basket Clip 105 may be of any suitable shape provided that it securely but reversibly engages the longline and allows rotation of the clip (and therefore of the basket once attached) about the axis of the longline.

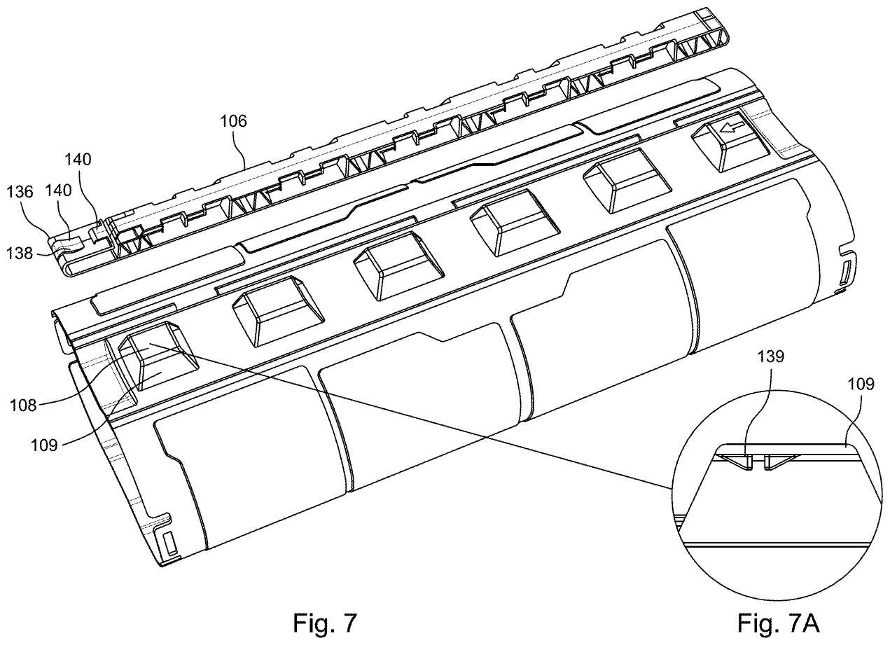

FIGS. 7 to 11 show the engagement of locking bar 106 with loops 108. FIG. 7 shows locking bar 106 with latch 138 at distal end 136. Latch 138 includes preferably two depressible tabs 140 that are configured to latch with a latch catch 139 within latch catch loop 109 shown in FIG. 7A. Latch catch 139 may be formed from two internal protrusions located on the interior surface of the end loop (latch catch loop 109). It will be appreciated that other configurations are possible to latch the locking bar with the loop without departing from the scope of the present disclosure.

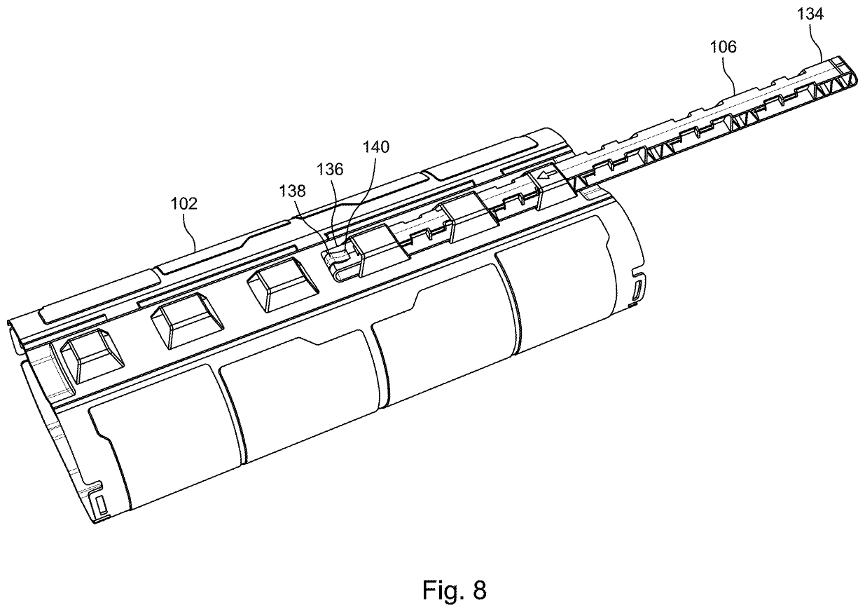

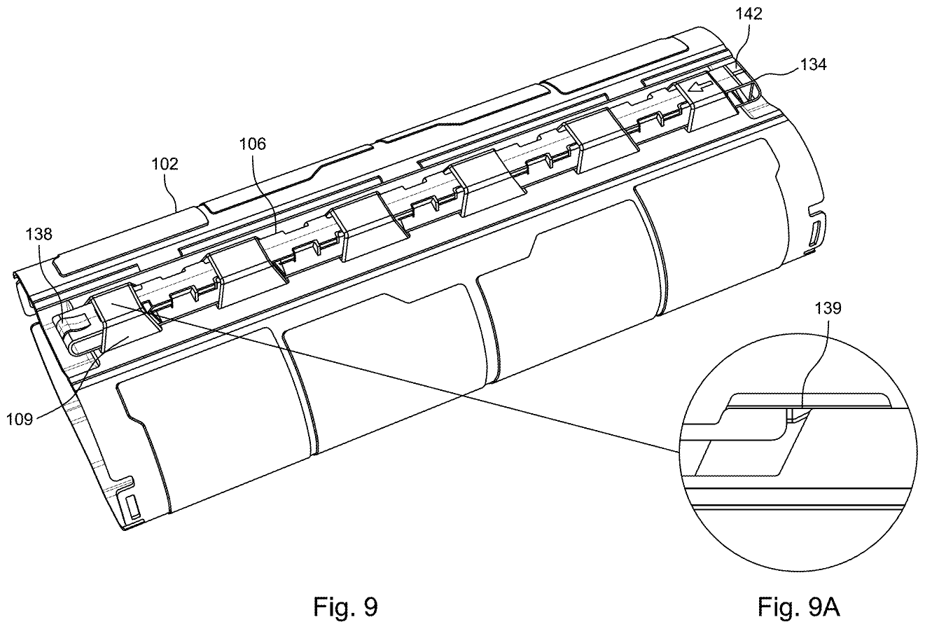

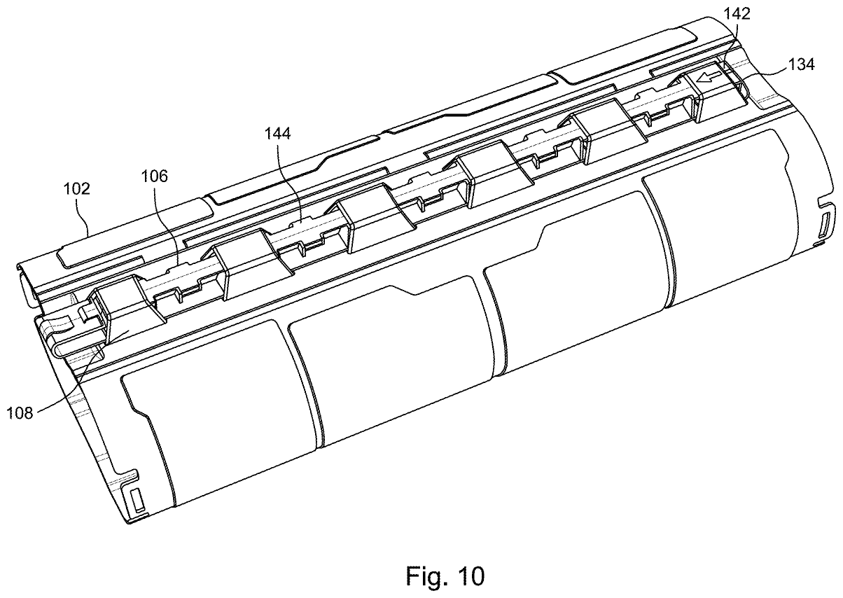

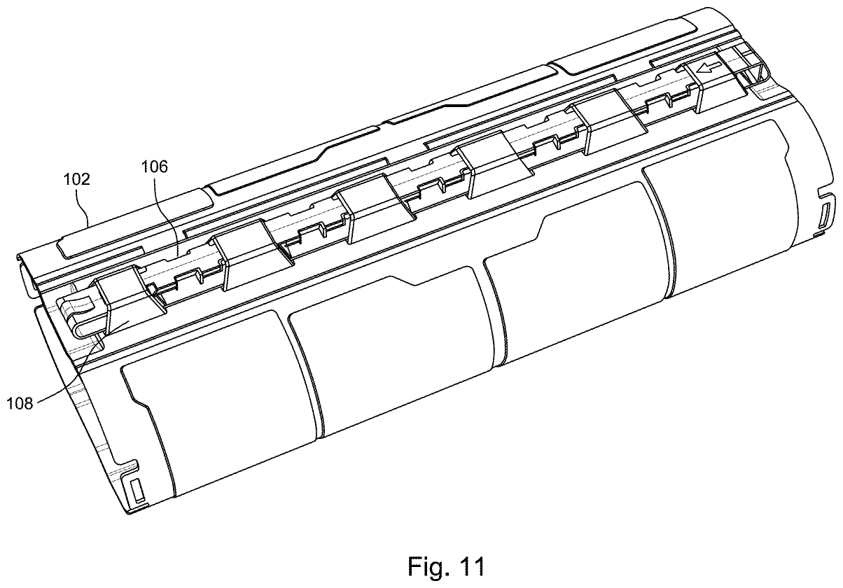

FIG. 8 shows locking bar 106 being slid into the array of loops along the length of the top of basket 102. Locking bar 106 is slid distally until distal end 136 protrudes from the last loop (latch catch loop 109) along the array, as shown in FIG. 9, exposing latch 138. End stop 142 at proximal end 134 inhibits any further movement of the locking bar into the loops as shown in FIG. 10. When the locking bar is at its most forward position so that end stop 142 is against the proximal loop, attachment points 144 are exposed between each loop 108. In this configuration, placement of the basket and locking bar combination against and into the lower surface of clip lock 146 permits the interdigitation of feet 154 with the attachment points so that a reverse direction sliding of locking bar 106 (shown in FIG. 11) slides over feet 154 to lock feet 154 (and therefore clip lock 146) to the basket. Prior to sliding locking bar 106 over feet 154, bottom bar 164 of clip 105 is inserted into inner recess 150 so that clip 105 is able to rotate relative to clip lock 146, with bottom bar 164 being limited by curvilinear inner recess 150. Sliding locking bar 106 over feet 154 therefore entraps bottom bar 164 within inner recess 150, as shown in FIG. 1. Withdrawing locking bar 106 in a rearward direction disengages the locking bar from the loops and clip lock, permitting basket 102 to easily detach from the longline while keeping the clip assembly engaged to the longline.

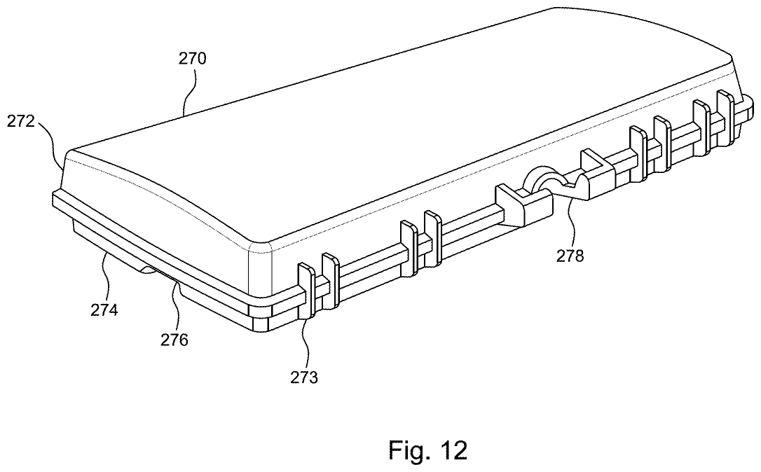

Referring now to FIGS. 12 to 16, a system 200 is shown in accordance with another preferred embodiment of the present description. System 200 is similar to system 100 except that the longline engagement means is configured for use with a float 270. Referring to FIG. 12, float 270 includes an upper casing 272, a lower casing 274, and a locking bar aperture 276. Float 270 further includes a flip adaptor aperture 278 for engagement with a flip adaptor 204. Float 270 also preferably includes a plurality of float casing clips 273 to engage upper casing 272 to lower casing 274.

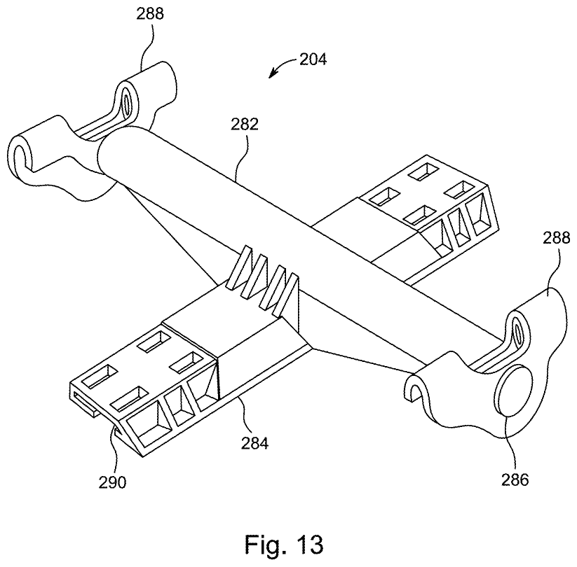

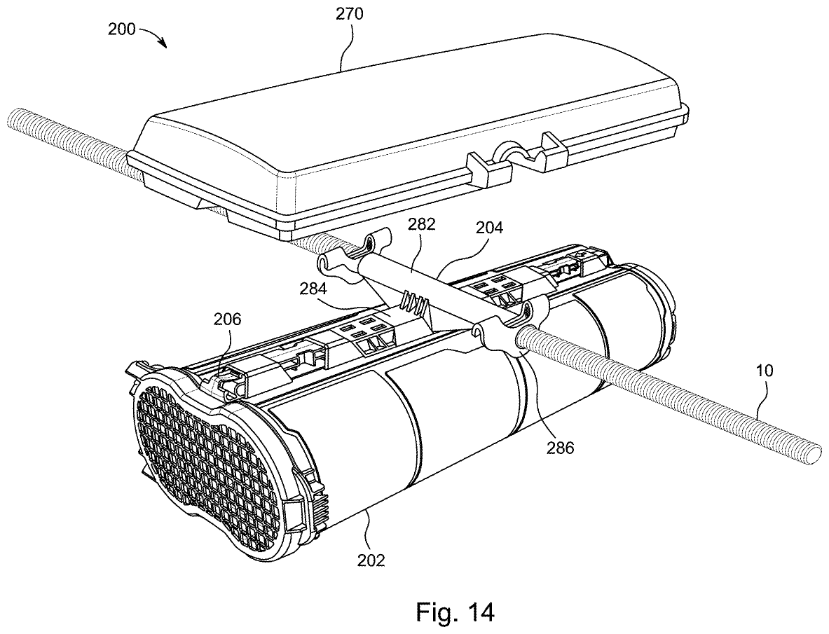

The longline engagement means, shown as flip adaptor 204 in FIG. 13, includes an upper body portion 282 and a lower body portion 284. Lower body portion 284 is oriented transverse relative to upper body portion 282. Upper body portion 282 includes a longline through hole 286 configured to receive longline 10 (FIG. 14) therethrough. Upper body portion 282 also includes at least one, more preferably, two opposed upper float flanges 288 configured to engage with a portion of float 270.

With continued reference to FIG. 13, lower body portion 284 includes a locking bar aperture 290 configured to slidably receive locking bar 206 therethrough.

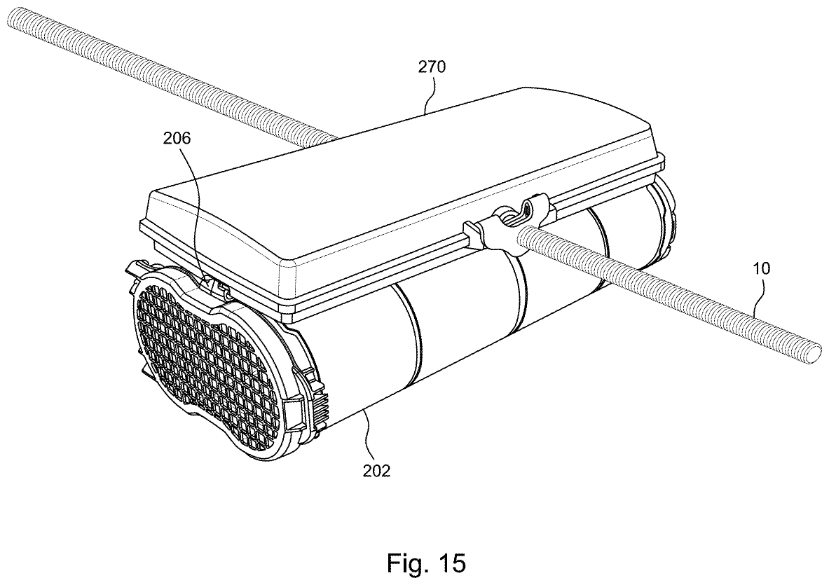

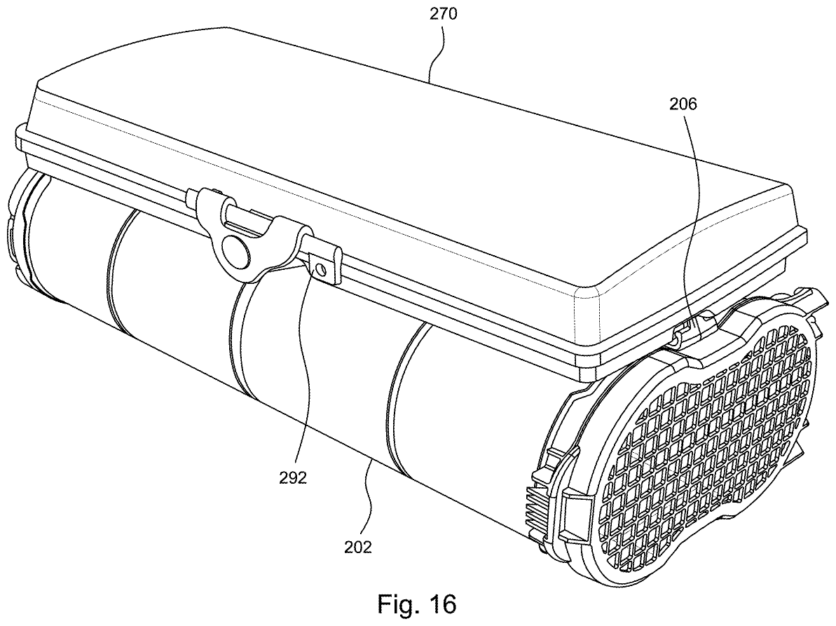

Referring to FIGS. 14 and 15, the float and basket combination is assembled by stringing longline 10 through longline through hole 286. Basket 202 is positioned against lower body portion 284 with locking bar 206 in a similar engagement position as described above in system 100. Locking bar 206 is then slid proximally to engage basket 202 to flip adaptor 204 as shown in FIG. 14, with the length of the basket parallel to the length of lower body portion 284 of the flip adaptor, and transverse to the longline. Thereafter, float 270 is engaged to upper body portion 282 of the flip adaptor to sandwich the flip adaptor between the float and the basket, arriving at the fully engaged position shown in FIG. 15. Referring to FIG. 16, a locking pin may be inserted into float 270 to lock the float with float locking mechanism 292.

Basket 202 is disengaged from the longline while keeping the float engaged to the longline by withdrawing locking bar 206 in a rearward direction.

While basket 202 is engaged to the longline, it may be flipped about the longline so that the length of the basket is flipped around the longline. It will be appreciated that the basket may be attached to the longline with an appropriately configured flip adaptor so that the width of the basket is flipped around the longline if desired.

It will be appreciated that the steps described above may be performed in a different order, varied, or some steps omitted entirely without departing from the scope of the present description.

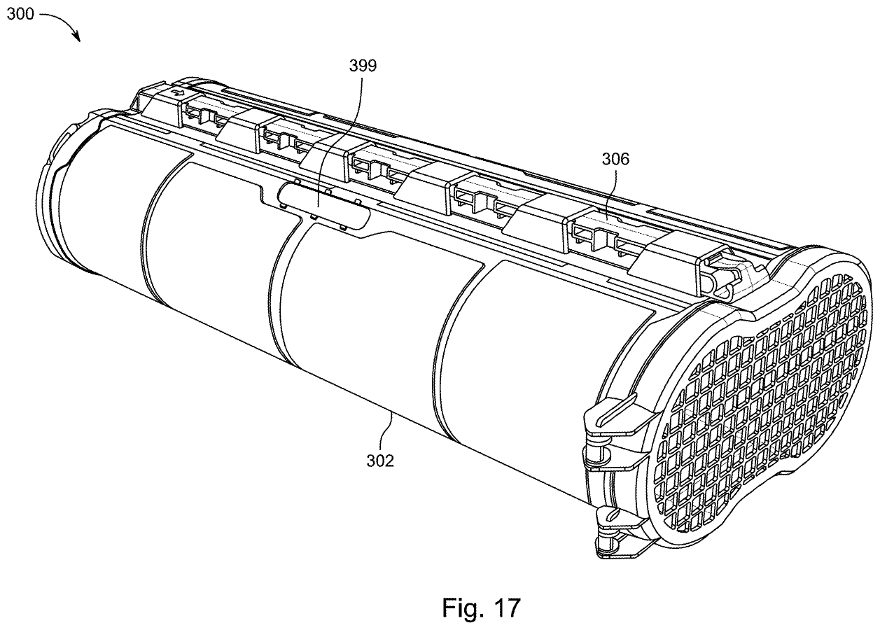

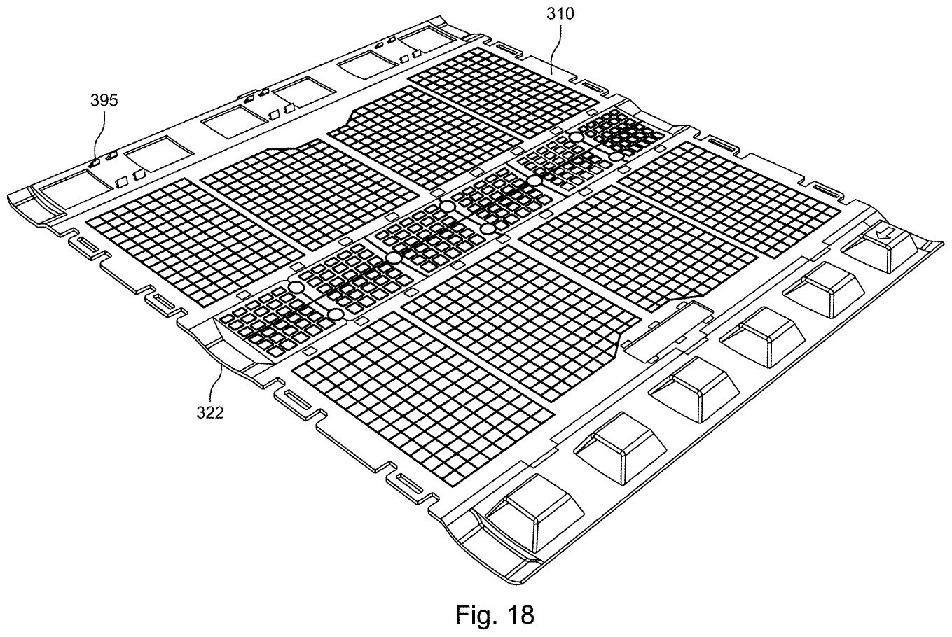

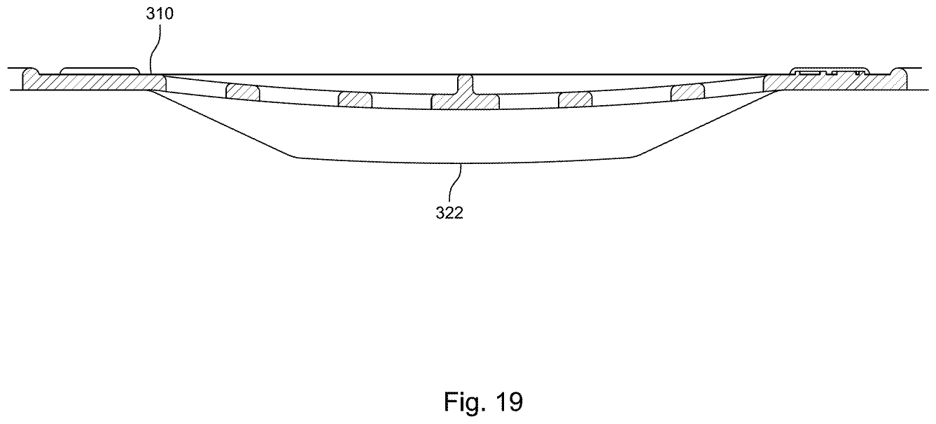

Referring now to FIGS. 17 to 21, a system 300 is shown in accordance with another preferred embodiment of the present description. System 300 is similar to system 100 except that as shown in FIGS. 18 and 19, sheet 310 has a centre portion 322 that is concave while sheet 310 is in its unengaged state. When sheet 310 is assembled into its engaged state, as shown in FIG. 17, centre portion 322 becomes a flat surface to facilitate an even spread of oysters or other aquatic life in the basket, which contributes to consistent growth of the aquatic life.

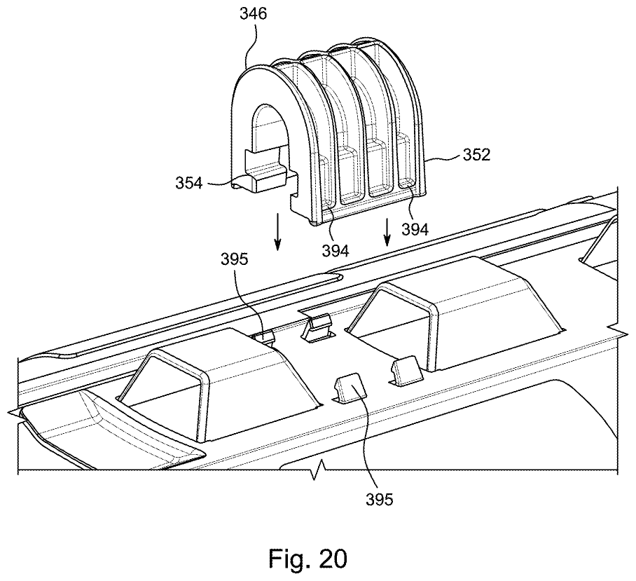

FIG. 20, shows clip lock 346 for engagement with basket 302 and locking bar 306. Clip lock 346 is similar to clip lock 146 except that clip lock 346 has a lower surface 352 that extends from a forward portion to rear portion. Lower surface 352 preferably is shaped with an internal surface 354 sized and configured or shaped to engage with locking bar 306 (FIG. 17). Clip lock 346 further preferably includes an external surface 394 at lower end 352 configured to interdigitate with tabs 395 of basket 302. In use, clip lock 346 is positioned over assembled basket 302 and then moved downwardly to engage external tab surface 394 of clip lock 346 with tabs 395 of basket 302 in a snap-fit engagement. Thereafter, locking bar 306 (FIG. 17) may be slid over internal surface 354 to secure clip lock 346 to the basket. Tabs 395 help secure clip lock 346 in place on the basket during the sliding of locking bar 306 through the clip lock. Withdrawing locking bar 306 in a rearward direction disengages the locking bar from the loops and clip lock, permitting an easy and quick maintenance procedure to replace worn parts in the future.

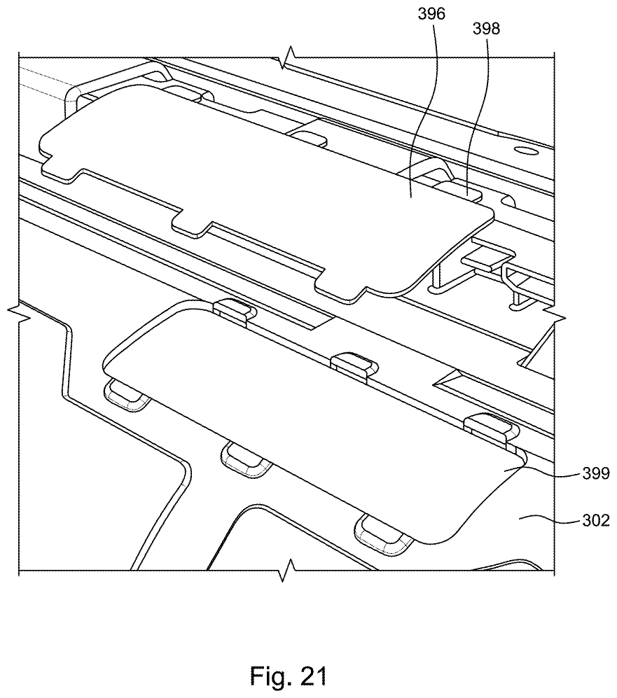

FIG. 21 shows an upper surface of assembled basket 302 including an ID plate or tag 396. ID plate 396 may snap-fit into place with engagement tabs 398. ID plate 396 provides the ability for users to identify individual baskets. ID plate 396 may be formed as a transparent cover to envelope a printed label, or may itself be a printed, laser-etched, or engraved ID tag. Alternatively, ID plate may include a QR code or bar code for non-contact scanning and identification. As another alternative, ID plate may be formed as a cover to contain a RFID chip within a compartment 399 covered by ID plate 396. The identification associated with ID plate 396 may include one or more of the company name, and batch number.

The foregoing description is by way of example only, and may be varied considerably without departing from the scope of the present invention. For example only, the basket may have mesh sides or solid sides. Graduation markers may be included along exterior of the base of the basket to help aid in farm management, and facilitate consistent stocking densities. The basket may be formed from a variety of materials, but preferably materials resistant to corrosive effects of salt water where use is contemplated in seawater.

Other longline engagement means may be used other than hooks or a flip adaptor. It will be appreciated that although use has been described in relation to a flexible structure such as a longline, the engagement means may be configured for use with rigid structures such as a trestle (e.g., French trestle), a ladder, or any other similar structure.

Where floatation is utilised (it need not be), a variety of floatation devices may be used. The locking bar may be a solid linear length of rigid material, but may also be formed as a partially hollow, curved material as desired.

The engagement means may be configured so that the length of the basket is oriented transverse to the longline (where used), or configured so that the length of the basket is parallel to the longline (where used). Flipping, when used, may be according to the orientation of the basket relative to the longline or other structure.

Some embodiments of the basket according to the invention comprise engagement means on the underside of the basket to enable attachment or engagement with additional components useful to the application at hand. Such engagement means may be of any suitable type, for example, a second locking bar mechanism, or clips or reinforced location points for attachment of such components.

The features described with respect to one embodiment may be applied to other embodiments, or combined with or interchanged with the features of other embodiments, as appropriate, without departing from the scope of the present disclosure.

The one or more of the various embodiments described in the present disclosure in a preferred form provide the advantages of easy engagement and disengagement of the basket with the longline or other structure, vastly increasing harvesting efficiency often plaguing conventional systems.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system for attaching an aquatic basket to a longline in an aquaculture farming environment, comprising:
an aquaculture basket configured to hold aquatic life therein, the basket having a first end, a second end opposite said first end, an upper surface, a lower surface, and a length from said first end to said second end, said upper surface including at least one aperture oriented along the length;
a longline engagement means configured to hold said basket to the longline; and
a locking bar configured for slidable engagement with said at least one aperture of said upper surface of said basket and a portion of said longline engagement means to releasably secure said basket to said longline engagement means.

2. The system of claim 1, wherein said longline engagement means comprises:
an upper body portion including a through-aperture configured to receive at least a portion of the longline therethrough; and
a lower body portion configured to slidably receive a portion of said locking bar to secure the basket to said lower body portion.

3. The system of either claim 1 or 2, wherein said longline engagement means is configured to engage to a basket float.

4. The system of claim 3, wherein said longline engagement means is configured to permit disengagement of said basket while remaining engaged to the float.

5. The system of either claim 3 or 4, wherein said longline engagement means is configured to be sandwiched between the float and the basket when the basket and float are engaged thereto.

6. The system of claim 1, further comprising a plurality of longline engagement means configured for engagement with said locking bar to releasably secure the basket to the longline.

7. The system of claim 1, wherein said longline engagement means comprises a basket clip and separate clip lock engageable with one another.

8. The system of claim 7, wherein said clip lock is configured to slidably receive a portion of said locking bar along a bottom surface of said clip lock to entrap said clip between said locking bar and said clip lock.

9. The system of either claim 7 or 8, wherein said clip lock comprises a recess configure to receive a lower portion of said basket clip therein.

10. The system of any one of claims 7 to 9, wherein said clip lock includes a tab engagement surface configured to engage tabs extending from said upper surface of said basket.

11. A quick release for engaging an aquaculture basket to a float and a longline, comprising:
an upper body portion including a through-aperture configured to receive at least a portion of the longline therethrough, said upper body portion including an engagement means configured to secure to the float; and
a lower body portion configured to slidably receive a portion of a locking bar to secure the basket to said lower body portion.

12. The quick release of claim 11, wherein said lower body portion is oriented transverse to said upper body portion so that the basket is secured to the longline with its length perpendicular to the longline.

13. The quick release of claim 11, wherein said lower body portion is oriented parallel to said upper body portion so that the basket is secured to the longline with its length parallel with the longline.

14. The quick release of any one of claims 11-13, wherein said upper and lower body portions each have an overall length that is substantially equal.

15. The quick release of any one of claims 11-14, wherein said through aperture of said upper body portion has a complete perimeter so that the longline is strung through the quick release to engage the quick release to the longline.

16. The quick release of any one of claims 11-15, wherein said lower body portion includes a tab engagement surface configured to engage tabs extending from an upper surface of the basket.

17. A quick release for engaging an aquaculture basket to a longline, comprising:
a locking bar;
a basket clip including a first end configured to clip onto the longline, and a second end opposite said first end, said second end including a bottom bar; and
a clip lock including a curvilinear upper surface, an inwardly oriented curvilinear recess configured to receive the bottom bar of said basket clip therein, and a lower surface including an engagement means configured to slidably receive said locking bar.

18. The quick release of claim 17, wherein said locking bar has a length approximately equal to a length of the basket.

19. The quick release of either claim 17 or 18, wherein said first end of said basket clip is hook-shaped.

20. The quick release of any one of claims 17-19, wherein said first and second ends of said basket clip each comprise a through hole having a central axis that are parallel to one another.

21. The quick release of any one of claims 17-20, wherein said lower surface of said clip lock comprises a plurality of feet configured to engage with said locking bar.

22. The quick release of any one of claims 17-21, wherein said lower surface of said clip lock is configured to slidably receive said locking bar in a transverse orientation relative to the longline.

23. The quick release of any one of claims 17-21, wherein said lower surface of said clip lock is configured to slidably receive said locking bar in a parallel orientation relative to the longline.

24. The system of any one of claims 17-23, wherein said clip lock includes a tab engagement surface configured to engage tabs extending from an upper surface of the basket.

25. A method for attaching an aquatic basket to a longline in an aquaculture farming environment, comprising:
attaching an engagement means to the longline;
positioning the basket proximate the engagement means; and
sliding a locking bar through the engagement means to secure the basket to the engagement means.

26. The method of claim 25, wherein the step of sliding the locking bar through the engagement means comprises sliding the locking bar through a plurality of engagement means.

27. The method of either claim 25 or 26, wherein the step of sliding the locking bar through the engagement means comprises sliding the locking bar through an engagement means that is secured to a float.

28. The method of claim 27, further comprising disengaging the basket from the float while keeping the float engaged to the longline.

29. The method of either claim 27 or 28, further comprising flipping the basket about the longline.

30. The method of either claim 25 or 26, further comprising flipping the basket about the longline so that a length of the basket is flipped around the longline.

31. The method of any one of claims 25-28, further comprising flipping the basket about the longline while the float is engaged with the longline and cage.

32. An apparatus for aquaculture farming comprising a piece of durable material which is deformable so as to substantially create an enclosure for housing a farmed aquaculture species, the piece of durable material comprising engagement means so that a first part of the durable material can engage with a second part thereof and thereby retain the durable material in the desired deformed state, substantially as an enclosure, wherein the shape of the durable material is such that once in the enclosure form, there are no gaps between engaged parts which are sufficiently large enough to allow an individual of the farmed aquaculture species from exiting the enclosure.

33. An assembly for attaching an aquaculture basket to a longline comprising a plurality of pre-formed thermoplastic components which are together operable to facilitate rotation of the basket in at least two planes.

34. An elongate member for attachment to and along the axis of an aquaculture basket to provide rigidity and support to the basket.
